(19) United States
(12) Patent Application Publication
(10) Pub. No.: US 2025/0373455 A1
(43) Pub. Date: Dec. 4, 2025

(54) HYBRID AUTHENTICATION USING QUANTUM KEY DISTRIBUTION

(71) Applicant: American Express Travel Related Services Company, Inc., New York, NY (US)

(72) Inventor: Andras L. Ferenczi, Scottsdale, AZ (US)

(21) Appl. No.: 18/676,590

(22) Filed: May 29, 2024

(51) Int. Cl. H04L 9/32; H04L 9/08

(52) U.S. Cl. CPC H04L 9/3297; H04L 9/0852; H04L 9/0861; H04L 9/3213

(57) ABSTRACT

Disclosed are various approaches for hybrid authentication using quantum key distribution. In some examples, a batch of authentication keys comprising a plurality of authentication keys can be generated. A key accumulator can be generated by inputting a respective authentication key of the plurality of authentication keys into an accumulator function. A respective witness can be generated for the respective authentication key to enable regeneration of the accumulator. A quantum key distribution channel can be used to transmit a batch of authentication maps comprising the respective witness and the respective authentication key.

### BACKGROUND

Authentication and digital proof of identity is a mainstay of digital interactions. In the digital world, a person can claim an identity, but if there is no proof of the veracity of the claim, then there can be little assurance that the person is who he or she claims to be. Unlike face-to-face introductions with a trusted person, or the validity provided by conversations in a physical storefront, Internet communications can be much more easily spoofed or falsified.

Enterprises can utilize authentication services to secure enterprise operations such as data access. Authentication can be a processing intensive activity. The authentication procedure can take a significant amount of time and processing power. When iterated over a large number of authentication requests authentication can involve significant energy expenditure and storage space.

Electronically transmitting authentication data can be fraught with security issues. If authentication data is compromised, then enterprise operations can be negatively affected. For example, bad actors can gain access to sensitive information, data can be corrupted or altered, and so on. In some examples, the authentication data can be compromised or intercepted without knowledge of the parties to the transmission.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a networked environment according to various embodiments of the present disclosure.

FIG. 2 is a sequence diagram illustrating the interactions between portions of the networked environment of FIG. 1 according to various embodiments of the present disclosure.

FIGS. 3A-3C are flowcharts illustrating functionality of an authentication service of the networked environment of FIG. 1 according to various embodiments of the present disclosure.

FIG. 4 is a flowchart illustrating functionality of an enterprise service of the networked environment of FIG. 1 according to various embodiments of the present disclosure.

FIG. 5 is a flowchart illustrating functionality an application on a client device of the networked environment of FIG. 1 according to various embodiments of the present disclosure.

### DETAILED DESCRIPTION

Disclosed are various approaches for hybrid authentication using quantum key distribution. Enterprises can utilize authentication services to secure enterprise operations such as data access. Traditional authentication operations can take a significant amount of time, processing power, energy expenditure, and storage space. Furthermore, electronically transmitting authentication data can be fraught with security issues, including the risk of authentication data being intercepted or compromised without knowledge of the parties to the transmission. The present disclosure describes mechanisms that can reduce the time, processing power, energy expenditure, and storage space used for authentication services while also providing a tamperproof key distribution. For example, an authentication service can generate a batch of authentication keys, generate an accumulator by iteratively inputting the respective keys into an accumulator generation function, generate a witness for a respective key, transmitting a batch of key-witness pairs using a quantum key distribution channel, confirm validity of the key by regenerating the accumulator using the key-witness pair and a verification function such as the accumulator generation function, and providing an access token or other limited-use protected resource access data if the key is valid. Key revocation can be achieved using a revocation accumulator, and ensuring that the key is not in the revocation accumulator prior to providing the protected resource access data.

The described framework for hybrid authentication using quantum key distribution can provide a number of improvements over other technologies in the field including: increased efficiency provided by reduced memory, processing, and energy usage of key verification by regenerating the accumulator using an authentication map (e.g., key-witness pair) and an accumulator generation function as a verification process; ensuring untampered and secure transmission of a batch of authentication maps by using a quantum key distribution channel; reducing data storage of the authentication provider service by storing authentication data that in various examples includes or is limited to the accumulator value; reducing data storage by enabling at least a portion of the key and witness data to be unindexed when stored in the authentication service, among other speed and efficiency benefits of these mechanisms relative to devices and systems that do not have the described mechanisms.

In the following discussion, a general description of the framework for hybrid authentication using quantum key distribution is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

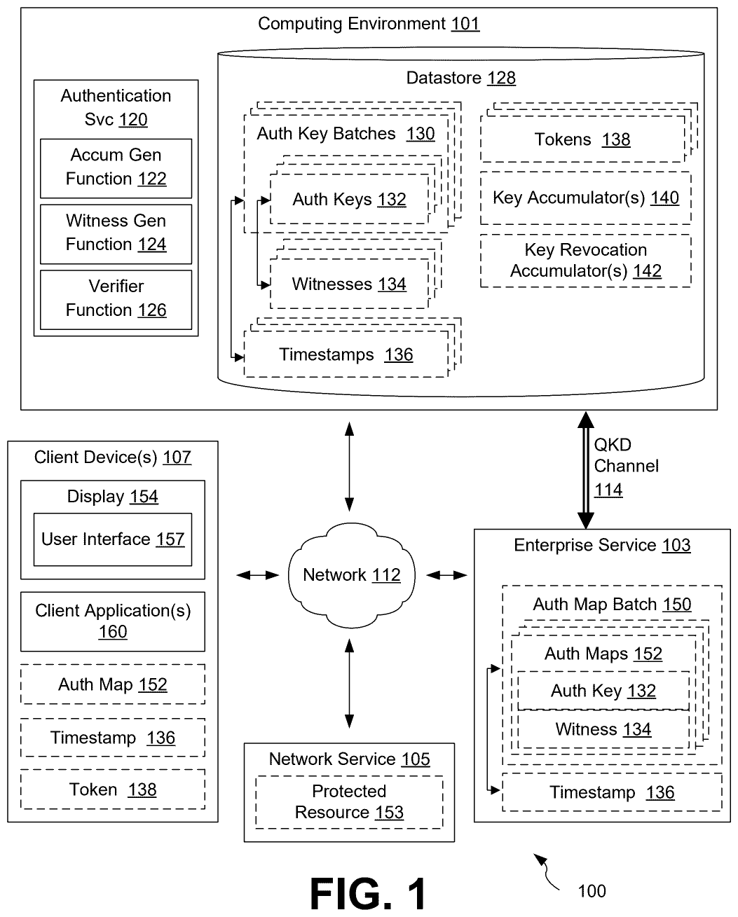

With reference to FIG. 1, shown is a networked environment 100 according to various embodiments. The networked environment 100 can include a computing environment 101, an enterprise service 103, a network service 105, and a client device 107, which can be in data communication with each other via a network 112. A quantum key distribution channel 114 can connect the computing environment 101 with an enterprise computing environment of the enterprise service 103. Although depicted and described separately, the network service 105 can also be included in or operate as a subcomponent of the computing environment 101 and/or the enterprise service 103 in various embodiments of the present disclosure.

The network 112 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 112 can also include a combination of two or more networks 112. Examples of networks 112 can include the Internet, intranets, extranets, virtual private networks (VPNs), and similar networks.

The computing environment 101 can include one or more computing devices that include a processor, a memory, and/or a network interface. For example, the computing devices can be configured to perform computations on behalf of other computing devices or applications. As another example, such computing devices can host and/or provide content to other computing devices based at least in part on requests for content. Moreover, the computing environment 101 can employ a plurality of computing devices that can be arranged in one or more server banks or computer banks or other arrangements. Such computing devices can be located in a single installation or can be distributed among many different geographical locations. For example, the computing environment 101 can include a plurality of computing devices that together can include a hosted computing resource, a grid computing resource or any other distributed computing arrangement. In some cases, the computing environment 101 can correspond to an elastic computing resource where the allotted capacity of processing, network, storage, or other computing-related resources can vary over time. Various applications or other functionality can be executed in the computing environment 101. The components executed on the computing environment 101 include an authentication service 120, and other applications, services, processes, systems, engines, or functionality not discussed in detail herein.

The authentication service 120 can provide authentication services for an enterprise 103 and/or various client devices 107. The authentication service 120 can include an accumulator generation function 122, a witness generation function 124, and a verifier function 126.

Also, various data is stored in a datastore 128 that is accessible to the computing environment 101 and the authentication service 120. The datastore 128 can be representative of a plurality of datastores 128, which can include relational databases or non-relational databases such as object-oriented databases, hierarchical databases, hash tables or similar key-value datastores, as well as other data storage applications or data structures. Moreover, combinations of these databases, data storage applications, and/or data structures can be used together to provide a single, logical, datastore. The data stored in the datastore 128 is associated with the operation of the various applications or functional entities described below. This data can include authentication key batches 130 that include number of authentication keys 132, witnesses 134, timestamps 136, tokens 138, key accumulators 140, key revocation accumulators 142, and other data.

The authentication service 120 can use the accumulator generation function 122 to generate a key accumulator 140 by cryptographically processing a set of authentication keys 132 corresponding to an authentication key batch 130. The accumulator generation function 122 can include a one-way cryptographic function that takes set of authentication keys 132 as a set of inputs and produces a single value that “accumulates” all these inputs. This process can be performed iteratively for a respective authentication key 132 of the authentication key batch 130. In some examples, the key accumulators 140 can have a particular format such as a particular length, set of characters that can be used, and so on. In other examples, different key accumulators 140 or values can have different lengths, and other differing characteristics.

Given a key accumulator 140 value and a new input (e.g., a key), the accumulator generation function 122 can compute a new or updated key accumulator 140 value. The original set of inputs such as individual ones of the set of authentication keys 132 cannot be identified or extracted from the key accumulator 140 value. A witness 134 value can be generated for each input. The witness 134 value can be used to prove or verify that the input was accumulated in the key accumulator 140 value, without revealing the other inputs. In some examples, the witness 134 can have a particular format such as a particular length, set of characters that can be used, and so on.

The pseudocode in Table I shows a nonlimiting example that can provide an understanding of the cryptographic accumulator generation function 122.

TABLE I
def create_accumulator(batch_values):
accumulator = INITIAL_VALUE # Some predefined initial value
for value in batch_values:
accumulator = accumulate(accumulator, value)
return accumulator
def accumulate(current_accumulator, new_value):
# Perform a cryptographic operation, e.g., a hash function or modular
exponentiation
return cryptographic_operation(current_accumulator, new_value)

The “batch_values” can refer to a set of authentication keys 132 corresponding to an authentication key batch 130. The “INITIAL_VALUE” can refer to any predetermined accumulator value. The actual cryptographic operations used, such as hash functions or other operations, can depend on the specific type of accumulator generation function 122. Types of accumulator generation function 122 can include an Rivest-Shamir-Adleman (RSA) accumulator, bilinear map accumulator, and so on.

The witness generation function 124 can include a function that can be used to generate a witness 134 for each authentication key 132 used as input to the accumulator generation function 122. The witness generation function 124 can iteratively perform a cryptographic operation using the subset of the set of authentication keys 132 that omits the particular authentication key 132. Without limitation, in some examples the witness generation function 124 can use the same cryptographic operation as the accumulator generation function 122. In such examples, the witness 134 can be similar to a key accumulator 140 in format. However, the witness 134 corresponding to a particular authentication key 132 can be an accumulator value cryptographically generated using a subset of the set of authentication keys 132 used for the key accumulator 140, where the subset omits the particular authentication key 132. As a result, the cryptographic operation (e.g., “accumulate”) can be performed on the particular authentication key 132 and its corresponding witness 134 to recreate the key accumulator 140. The pseudocode in Table II shows a nonlimiting example that can provide an understanding of the witness generation function 124.

TABLE II

def generate_witness(accumulator, batch_values, target_value):
witness = INITIAL_VALUE
for value in batch_values:
if value != target_value:
witness = accumulate(witness, value)
return witness

In this example, the “target value” can refer to the particular authentication key 132, and the “witness” can refer to the witness 134 for the particular authentication key 132.

The verifier function 126 can refer to a function that uses the particular authentication key 132 and its corresponding witness 134 to recreate the key accumulator 140. The verifier function 126 can also compare the recreated version of the key accumulator 140 to the pre-stored version of the key accumulator 140 to verify that the authentication key 132 is valid as an input that was used to generate the key accumulator 140. In this way, the verifier function 126 can confirm that the authentication key 132 is one of the set of authentication keys 132 of a particular authentication key batch 130. The pseudocode in Table III shows a nonlimiting example that can provide an understanding of the verifier function 126.

TABLE III
def verify_membership(accumulator, witness, target_value):
# Recreate the accumulator using the witness and the target value
potential_accumulator = accumulate(witness, target_value)
# Check if the recreated accumulator matches the original accumulator
return potential_accumulator == accumulator

The authentication keys 132 can refer to any unique value or identifier such as a universally unique identifier. In some examples, the authentication keys 132 can each have a particular format such as a particular length, set of characters that can be used, and so on.

The timestamps 136 can be batch-specific to a particular authentication key batch 130. While referred to as timestamps 136, any batch-specific identifier can be used as an alternative to a timestamp 136. In some examples, timestamps 136 are not utilized. The use of timestamps 136 or other batch identifiers can enable parallel generation of authentication key batches 130 and corresponding key accumulators 140. This can also enable parallel generation of witnesses 134 for respective authentication keys 132 for the authentication key batches 130. In this context, parallel generation can refer to generation of multiple items with at least partial concurrency.

The tokens 138 can refer to a cryptographic authentication data that enables access to a particular resource or service such as the network service 105. A token 138 can be signed by the authentication service 120 so that the network service 105 can identify validity, authenticity, and origin of the token 138.

A key revocation accumulator 142 can include a cryptographically generated accumulator value that accumulates a set of all revoked authentication keys 132 and/or authentication key batches 130. Authentication keys 132 and authentication key batches 130 can be revoked based at least in part on events such as an expiration of a predetermined time, an identification of a data breach or security threat, a user or administrator request, and other events. In some examples, the key revocation accumulator 142 can be generated using the accumulator generation function 122, and the witness generation function 124 can generate a “revocation” witness 134 for the revoked authentication key 132. The revocation witness can be retrieved using the authentication key 132. The revocation witness and the revoked authentication key 132 can be used to recreate the key revocation accumulator 142 using the verifier function 126.

However, in alternative embodiments, the key revocation accumulator 142 can refer to a version of an accumulator that is not generated using the accumulator generation function 122 that generates the key accumulator 140. In this example, the revoked authentication key 132 and the key revocation accumulator 142 can be input into a cryptographic function that determines whether the revoked authentication key 132 was used to generate the key revocation accumulator 142, without the use of a witness 134.

The enterprise service 103 can be a service that is executing using an enterprise computing environment. The enterprise computing environment can include one or more computing devices that include a processor, a memory, and/or a network interface. For example, the computing devices can be configured to perform computations on behalf of other computing devices or applications. As another example, such computing devices can host and/or provide content to other computing devices based at least in part on requests for content. Moreover, the computing environment 101 can employ a plurality of computing devices that can be arranged in one or more server banks or computer banks or other arrangements. Such computing devices can be located in a single installation or can be distributed among many different geographical locations. For example, the enterprise computing environment can include a plurality of computing devices that together can include a hosted computing resource, a grid computing resource or any other distributed computing arrangement. In some cases, the enterprise computing environment can correspond to an elastic computing resource where the allotted capacity of processing, network, storage, or other computing-related resources can vary over time. Various applications or other functionality can be executed in the enterprise computing environment. The components executed on the enterprise computing environment include the enterprise service 103, and other applications, services, processes, systems, engines, or functionality not discussed in detail herein.

Also, various data is stored in a datastore that is accessible to the enterprise computing environment and the enterprise service 103. The datastore can be representative of a plurality of datastores, which can include relational databases or non-relational databases such as object-oriented databases, hierarchical databases, hash tables or similar key-value datastores, as well as other data storage applications or data structures. Moreover, combinations of these databases, data storage applications, and/or data structures can be used together to provide a single, logical, datastore. The data stored in the datastore is associated with the operation of the various applications or functional entities described below. This data can include authentication map batches 150 of authentication maps 152, as well as timestamps 136.

The enterprise service 103 can receive the authentication map batches 150 and the timestamps 136 through the quantum key distribution channel 114. The quantum key distribution channel 114 can include an optical fiber or other quantum channel. The quantum key distribution channel 114 can use a quantum data transmission protocol such as the Bennet Brassard '84 (BB84) protocol or data transmission scheme to ensure that the authentication map batches 150 and the timestamps 136 are uncompromised. The BB84 protocol can include preparing a sequence of photons that represents bits of data corresponding to the authentication map batches 150 and the timestamps 136. The BB84 protocol can include preparing a sequence of photons that represents bits of data corresponding to the authentication map batches 150 and the timestamps 136.

The authentication service 120 can polarize photons with a randomly chosen base selected, for example, between rectilinear or diagonal bases. In rectilinear polarization, binary data can be represented using vertical and horizontal bits, where a vertical photon can represent a ‘0’ and horizontal can represent a ‘1’ or vice versa. In diagonal polarization, binary data can be represented using 45 degree and 135 degrees bits, where a 45 degree photon can represent a ‘0’ and 135 degrees bits can represent a ‘1’ or vice versa. Upon receiving each photon, the enterprise service 103 can randomly choose one of the two bases, between rectilinear or diagonal and records the outcome of ‘0’ or ‘1.’ The authentication service 120 can use a network 112 connection to transmit the enterprise service 103 data indicating the base used for each bit. The quantum key distribution channel 114 can enable detection of compromised data since reading a photon-based optical bits can change its value. For example, the authentication service 120 can transmit values for a subset of the bits to the enterprise service 103. The enterprise service 103 can determine whether the data is compromised based at least in part on an error rate of the subset of the bits.

The authentication maps 152 can refer to key-witness pairs generated by the authentication service 120. For example, an authentication map 152 can refer to a key-witness pair of an authentication key 132 and a corresponding witness 134 that can be used to recreate a particular authentication key accumulator 140 for an authentication key batch 130. In some examples, the authentication map 152 can also include a timestamp 136. However, the timestamp 136 can also be provided as a separate file or data structure.

The network service 105 can include one or more application programming interfaces (APIs), websites, web applications, and other components that provide access to at least one protected resource 153. The APIs websites, web applications, and other components can be accessible to the client device 107 over the network 112. The network service 105 can be configured to enable access to the protected resource 153 by validating the tokens 138.

The client device 107 is representative of a plurality of client devices 106 that can be coupled to the network 112. The client device 107 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 107 can include one or more displays 154, such as liquid crystal displays (LCDs), gas plasma-based flat panel displays, organic light emitting diode (OLED) displays, electrophoretic ink (“E-ink”) displays, projectors, or other types of display devices. In some instances, the displays 154 can be a component of the client device 107 or can be connected to the client device 107 through a wired or wireless connection.

The client device 107 can be configured to execute various applications such as a client application 160 or other applications. The client application 160 can be executed in a client device 107 to access network content served up by the computing environment 101 or other servers, thereby rendering a user interface 157 on the displays 154. To this end, the client application 160 can include a browser, a dedicated application, or other executable, and the user interface 157 can include a network page, an application screen, or other user mechanism for obtaining user input. The client device 107 can be configured to execute client applications 160 such as browser applications, chat applications, messaging applications, email applications, social networking applications, word processors, spreadsheets, or other applications.

The client device 107 (e.g., using a client application 160) can authenticate with the enterprise service 103, for example, using a username and password, digital certificates, biometric data, or another type of credential. The client device 107 can then request access to a protected resource 153. The enterprise service 103 can provide an authentication map 152 and a corresponding timestamp 136 to the client device 107. The client device 107 can transmit the authentication map 152 and the timestamp 136 to the authentication service 120 for verification.

The authentication service 120 can use the timestamp 136 as a key to identify a particular authentication key accumulator 140. The authentication service 120 can use the authentication map 152 to generate a value. If the value matches the particular authentication key accumulator 140, then the authentication service 120 can transmit a token 138 that enables access to the protected resource 153.

The following sequence diagrams and flowcharts provide a general description of the operation of the various components of the networked environment 100. Although the general descriptions can provide provides an example of the interactions between the various components of the networked environment 100, other interactions between the various components of the networked environment 100 are also possible according to various embodiments of the present disclosure. Interactions described with respect to a particular figure or sequence diagram can also be performed in relation to the other figures and sequence diagrams herein.

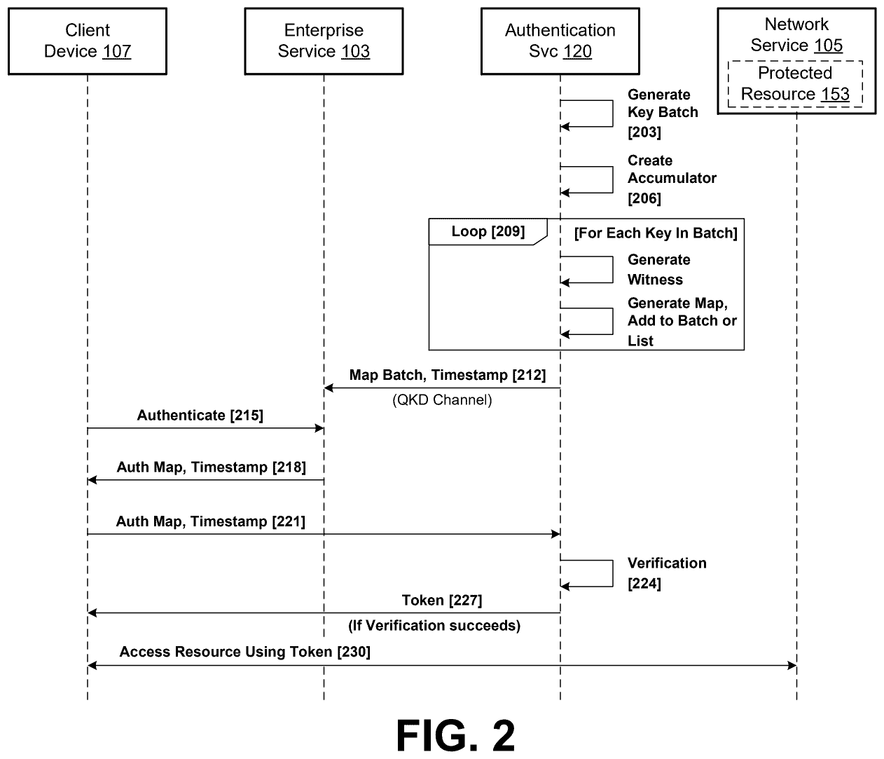

Referring next to FIG. 2, shown is a sequence diagram that provides one example of the interactions between the components of the networked environment 100 for hybrid authentication using quantum key distribution. The sequence diagram of FIG. 2 provides merely an example of the many different types of functional arrangements that can be employed to implement the depicted interactions between the components of the networked environment 100. As an alternative, the sequence diagram of FIG. 2 can be viewed as depicting an example of elements of a method implemented within the networked environment 100.

In block 203, the authentication service 120 can generate an authentication key batch 130. The authentication key batch 130 can refer to a batch of authentication keys 132. The authentication key batch 130 can include any 132 can refer to a unique identifier such as a universally unique identifier (UUID), a character string, or another type of uniquely identifying data. The authentication key batch 130 can be associated with a timestamp 136. The timestamp 136 or other unique batch identifier can be unique to the authentication key batch 130. This process can be completed in parallel, with partial concurrence, or sequentially.

The use of timestamps 136 or unique batch identifiers can be used for time-based and/or batch-based revocation. For example, a timestamp 136 can be revoked manually, or be revoked based at least in part on a predetermined event. The event can include passing of an elapsed time or detecting a security threat. However, revocation can also be performed on a per-key basis using a key revocation accumulator 142 (FIG. 1). If the timestamp 136 or associated batch is revoked, the authentication service 120 can refuse token requests (see block 221 below) that include the timestamp 136 or an authentication key 132 from an authentication key batch 130 of the timestamp 136. In some cases the authentication service 120 can delete the timestamp 136 and the key accumulator 140 for a revoked authentication key batch 130.

In block 206, the authentication service 120 can create a key accumulator 140 for the authentication key batch 130. This can involve cryptographically processing the authentication keys 132 of the authentication key batch 130 using the accumulator generation function 122 as discussed above. The accumulator generation function 122 can start with any arbitrary value. The accumulator generation function 122 can create a respective key accumulator 140 for a respective one of the authentication key batches 130. This process can be completed in parallel, with partial concurrence, or sequentially. In sequential embodiments, the accumulator generation function 122 can use the key accumulator 140 from a previous authentication key batch 130 as an initial value for the current key accumulator 140.

In block 209, the authentication service 120 can create a respective witness 134 for a respective one of the authentication keys 132 of the authentication key batch 130. The authentication service 120 can use a witness generation function 124 to create or generate the witnesses 134. The authentication service 120 can generate an authentication map batch 150 that includes a set of key-witness pairs or authentication maps 152. An authentication map 152 can refer to an authentication key 132 and a corresponding witness 134 that can be used in conjunction with a verifier function 126 to recreate the key accumulator 140.

In block 212, the authentication service 120 can transmit the authentication map batch 150 and the corresponding timestamp 136 through the quantum key distribution channel 114. The quantum key distribution channel 114 can include an optical fiber or other type of quantum channel. The quantum key distribution channel 114 can use a quantum data transmission protocol such as the BB84 protocol or data transmission scheme to ensure that the authentication map batches 150 and the timestamps 136 are uncompromised. The quantum key distribution channel 114 can enable detection of compromised data since reading a photon-based optical bits can change its value. For example, the authentication service 120 can transmit values for a subset of the bits to the enterprise service 103. The enterprise service 103 can determine whether the data is compromised based at least in part on an error rate of the subset of the bits.

In block 215, the client device 107 can authenticate with the enterprise service 103. The client device 107 can authenticate with the enterprise service 103 using a username and password, digital certificates, biometric data, or another type of credential. The client device 107 can request access to a protected resource 153.

In block 218, the enterprise service 103 can transmit an authentication map 152 and a corresponding timestamp 136 to the client device 107. In some examples, no timestamp 136 is used. The enterprise service 103 can track which authentication maps 152 have been used. In some examples, the authentication service 103 can maintain a data structure that relates a client device identifier or a user identifier to the authentication map 152 once it has been transmitted. The user identifier can identify a user of the client device 107.

In block 221, the client device 107 can transmit the authentication map 152 and the timestamp 136 to the authentication service 120 for verification. In some examples, no timestamp 136 is used. The transmission of the authentication map 152 and the timestamp 136 can be referred to as a token request.

In block 224, the authentication service 120 can perform a verification of the authentication map 152. For example, the authentication service 120 can use the authentication map 152 and a key accumulator 140 as input to the verification function 126 to generate a value. In examples where a timestamp 136 is provided, the timestamp 136 can be used as a key to identify a key accumulator 140 for the corresponding authentication key batch 130. In examples where no timestamp 136 is used, the authentication service 120 can use the most recent key accumulator 140. In some examples, requests that include authentication maps 152 (and authentication keys 132) for previous key accumulators 140 can be considered revoked, since they will fail to regenerate the current key accumulator 140.

In block 227, if the accumulator value generated using the verification function 126 matches the pre-stored key accumulator 140, the authentication service 120 can transmit a token 138 that enables access to the protected resource 153. This transmission of the token 138 can be considered a response to the token request.

In block 230, the client device 107 can access the protected resource 153 using the token 138. The client device 107 can authenticate with the network service 105 using the token 138, thereby gaining access to the protected resource 153. The network service 105 can be a portion of the enterprise service 103 in some examples.

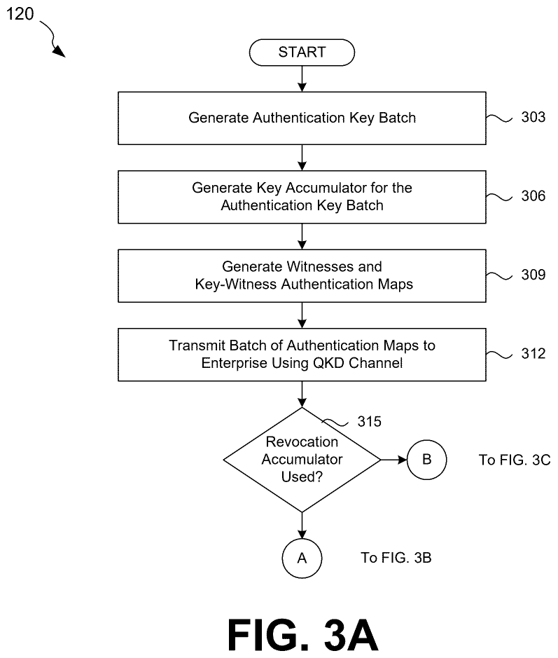

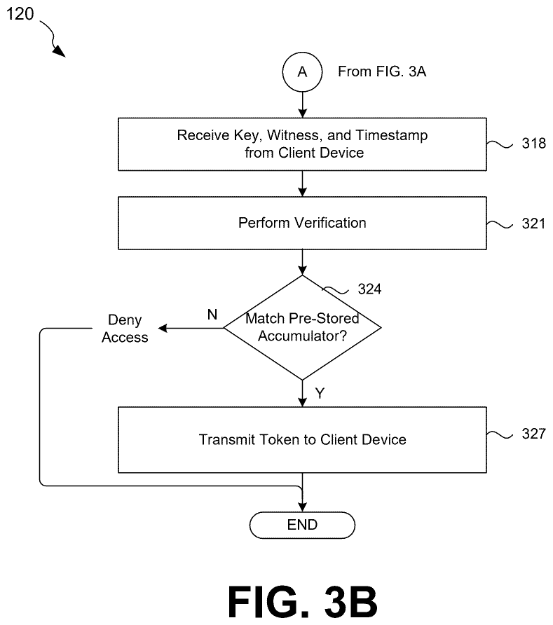

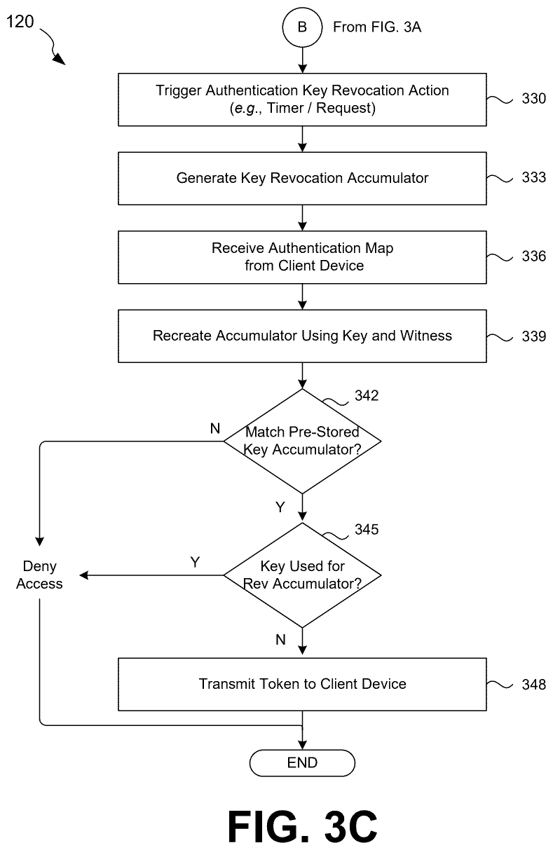

FIG. 3A shows a flowchart that provides one example of the operation of the authentication service 120 for hybrid authentication using quantum key distribution. The flowchart of FIG. 3 provides merely an example of the many different types of functional arrangements that can be employed to implement the depicted interactions between the components of the networked environment 100. As an alternative, the flowchart of FIG. 3A can be viewed as depicting an example of elements of a method implemented within the networked environment 100.

In block 303, the authentication service 120 can generate an authentication key batch 130. The authentication key batch 130 can refer to a batch of authentication keys 132. The authentication key batch 130 can include any 132 can refer to a unique identifier such as a UUID, a character string, or another type of uniquely identifying data. The authentication key batch 130 can be associated with a timestamp 136. The timestamp 136 or other unique batch identifier can be unique to the authentication key batch 130. This process can be completed in parallel, with partial concurrence, or sequentially.

In block 306, the authentication service 120 can create a key accumulator 140 for the authentication key batch 130. This can involve cryptographically processing the authentication keys 132 of the authentication key batch 130 using the accumulator generation function 122 as discussed above. The accumulator generation function 122 can start with any arbitrary value. The accumulator generation function 122 can create a respective key accumulator 140 for a respective one of the authentication key batches 130. This process can be completed in parallel, with partial concurrence, or sequentially. In sequential embodiments, the accumulator generation function 122 can use the key accumulator 140 from a previous authentication key batch 130 as an initial value for the current key accumulator 140.

In block 309, the authentication service 120 can create a respective witness 134 for a respective one of the authentication keys 132 of the authentication key batch 130. The authentication service 120 can use a witness generation function 124 to create or generate the witnesses 134. The authentication service 120 can generate an authentication map batch 150 that includes a set of key-witness pairs or authentication maps 152. An authentication map 152 can refer to an authentication key 132 and a corresponding witness 134 that can be used in conjunction with a verifier function 126 to recreate the key accumulator 140.

In block 312, the authentication service 120 can transmit the authentication map batch 150 and the corresponding timestamp 136 through the quantum key distribution channel 114. The quantum key distribution channel 114 can include an optical fiber or other type of quantum channel. The quantum key distribution channel 114 can use a quantum data transmission protocol such as the BB84 protocol or data transmission scheme to ensure that the authentication map batches 150 and the timestamps 136 are uncompromised. The quantum key distribution channel 114 can enable detection of compromised data since reading a photon-based optical bits can change its value. For example, the authentication service 120 can transmit values for a subset of the bits to the enterprise service 103. The enterprise service 103 can determine whether the data is compromised based at least in part on an error rate of the subset of the bits.

In block 324, the authentication service 120 can determine whether a key revocation accumulator 142 is to be used. If the key revocation accumulator 142 is to be used, the process can move to connector A, which connects to FIG. 3B. Otherwise, the process can move to connector B, which connects to FIG. 3C.

FIG. 3B shows a flowchart that provides an example of the operation of the authentication service 120 for hybrid authentication using quantum key distribution, and continuing from FIG. 3A. The flowchart of FIG. 3B shows one example where the process does not use a key revocation accumulator 142. The flowchart of FIG. 3B provides merely an example of the many different types of functional arrangements that can be employed to implement the depicted interactions between the components of the networked environment 100. As an alternative, the flowchart of FIG. 3B can be viewed as depicting an example of elements of a method implemented within the networked environment 100.

In block 318, the authentication service 120 can receive the authentication map 152 and the timestamp 136 from the client device 107 for verification. In some examples, no timestamp 136 is used. The transmission of the authentication map 152 and the timestamp 136 can be referred to as a request for authentication data that provides access to a protected resource 153. As indicated with respect to FIG. 2, the client device can receive the authentication map 152 and the timestamp 136 in based at least in part on a request to access the protected resource 153.

In block 321, the authentication service 120 can perform a verification of the authentication map 152. For example, the authentication service 120 can use the authentication map 152 and a key accumulator 140 as input to the verification function 126 to generate a value. In examples where a timestamp 136 is provided, the timestamp 136 can be used as a key to identify a key accumulator 140 for the corresponding authentication key batch 130. In examples where no timestamp 136 is used, the authentication service 120 can use the most recent key accumulator 140. In some examples, requests that include authentication maps 152 (and authentication keys 132) for previous key accumulators 140 can be considered revoked, since they will fail to regenerate the current key accumulator 140.

In block 324, the authentication service 120 can determine whether the accumulator value generated using the verification function 126 matches the pre-stored or original key accumulator 140. If the accumulator value generated using the verification function 126 and the authentication map 152 matches the original key accumulator 140, the process can move to block 324. Otherwise, access can be denied.

In block 327, the authentication service 120 can transmit a token 138 that enables access to the protected resource 153. This transmission of the token 138 can be considered a response to the token request. This can enable the client device 107 to access the protected resource 153 using the token 138.

FIG. 3C shows a flowchart that provides an example of the operation of the authentication service 120 for hybrid authentication using quantum key distribution, and continuing from FIG. 3A. The flowchart of FIG. 3C shows one example of how the authentication service 120 can generate and use a key revocation accumulator 142. The flowchart of FIG. 3C provides merely an example of the many different types of functional arrangements that can be employed to implement the depicted interactions between the components of the networked environment 100. As an alternative, the flowchart of FIG. 3C can be viewed as depicting an example of elements of a method implemented within the networked environment 100.

In block 330, the authentication service 120 can trigger an authentication key revocation action. Authentication keys 132 and authentication key batches 130 can be revoked based at least in part on trigger events such as an expiration of a predetermined time, an identification of a data breach or security threat, a user or administrator request, and other events. The authentication service 120 can detect the trigger event in association with a particular authentication key 132 or a group of authentication keys 132. While the group can refer to an authentication key batch 130, it can also include any group of authentication keys 132.

In block 330, the authentication service 120 can generate or update a key revocation accumulator 142. If a key revocation accumulator 142 exists, then the authentication service 120 can update the key revocation accumulator 142 to add the particular authentication key 132 or group of authentication keys 132 associated with the trigger event. In some examples, the key revocation accumulator 142 can be generated using the accumulator generation function 122, and the witness generation function 124 can generate a “revocation” witness 134 for the revoked authentication key 132. However, in alternative embodiments, the key revocation accumulator 142 can be generated using the authentication key 132 as an input, and the generation function can generate the key revocation accumulator 142 so that the revoked authentication key 132 and the key revocation accumulator 142 can be input into a cryptographic function that determines whether the revoked authentication key 132 was used to generate the key revocation accumulator 142, without the use of a witness 134.

In block 336, the authentication service 120 can receive the authentication map 152 and the timestamp 136 from the client device 107 for verification. In some examples, no timestamp 136 is used. The transmission of the authentication map 152 and the timestamp 136 can be referred to as a request for authentication data that provides access to a protected resource 153. As indicated with respect to FIG. 2, the client device can receive the authentication map 152 and the timestamp 136 in based at least in part on a request to access the protected resource 153.

In block 339, the authentication service 120 can perform a verification of the authentication map 152. For example, the authentication service 120 can use the authentication map 152 and a key accumulator 140 as input to the verification function 126 to generate a value. In examples where a timestamp 136 is provided, the timestamp 136 can be used as a key to identify a key accumulator 140 for the corresponding authentication key batch 130. In examples where no timestamp 136 is used, the authentication service 120 can use the most recent key accumulator 140. In some examples, requests that include authentication maps 152 (and authentication keys 132) for previous key accumulators 140 can be considered revoked, since they will fail to regenerate the current key accumulator 140.

In block 342, the authentication service 120 can determine whether the accumulator value generated using the verification function 126 matches the pre-stored or original key accumulator 140. If the accumulator value generated using the verification function 126 and the authentication map 152 matches the original key accumulator 140, the process can move to block 345. Otherwise, access can be denied.

In block 345, the authentication service 120 can determine whether the authentication key 132 in the authentication map 152 is used for the key revocation accumulator 142. The authentication key 132 can be ‘used for’ or a ‘member’ of the key revocation accumulator 142 if the authentication key 132 was used as an input to generate the key revocation accumulator 142. In examples that use a revocation witness, the authentication service 120 can retrieve the revocation witness using the authentication key 132. The revocation witness and the revoked authentication key 132 can be used to recreate the key revocation accumulator 142 using the verifier function 126. However, in other examples, an accumulator that is not generated using the accumulator generation function 122 that generates the key accumulator 140. In this example, the revoked authentication key 132 and the key revocation accumulator 142 can be input into a cryptographic function that determines whether the revoked authentication key 132 is used to generate the key revocation accumulator 142, without the use of a witness 134. If the authentication key 132 is used to create the key revocation accumulator 142, the process can move to block 348. Otherwise, access can be denied.

In block 348, the authentication service 120 can transmit a token 138 that enables access to the protected resource 153. This transmission of the token 138 can be considered a response to the token request. This can enable the client device 107 to access the protected resource 153 using the token 138.

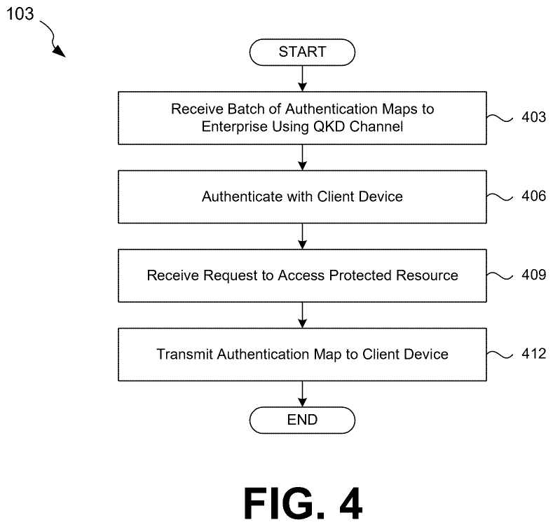

FIG. 4 shows a flowchart that provides an example of the operation of the enterprise service 103 for hybrid authentication using quantum key distribution. The flowchart of FIG. 4 provides merely an example of the many different types of functional arrangements that can be employed to implement the depicted interactions between the components of the networked environment 100. As an alternative, the flowchart of FIG. 4 can be viewed as depicting an example of elements of a method implemented within the networked environment 100.

In block 403, enterprise service 103 can receive the authentication map batch 150 and the corresponding timestamp 136 through the quantum key distribution channel 114. In some examples, the enterprise service 103 can use a network 112 to transmit a request for an authentication map batch 150, and the authentication map batch 150 and the corresponding timestamp 136 can be received based at least in part on the request. The quantum key distribution channel 114 can include an optical fiber or other type of quantum channel. The quantum key distribution channel 114 can use a quantum data transmission protocol such as the BB84 protocol or data transmission scheme to ensure that the authentication map batches 150 and the timestamps 136 are uncompromised.

The quantum key distribution channel 114 can enable detection of compromised data since reading a photon-based optical bits can change its value. The enterprise service 103 can use a network 112 to transmit values for a subset of the bits to the authentication service 120. The authentication service 120 can determine whether the data is compromised based at least in part on an error rate of the subset of the bits, and transmit a notification that indicates whether the data is compromised to the enterprise service 103. Alternatively, the enterprise service 103 can receive values for a subset of the bits from the authentication service 120 over the network 112. The authentication service 120 can determine whether the data is compromised based at least in part on an error rate of the subset of the bits.

In block 406, the enterprise service 103 can authenticate with the client device 107. The enterprise service 103 can provide a network-accessible service such as a website, web application, or another service that can be accessed using a client device 107. The enterprise service 103 can receive credentials such as a using a username and password, digital certificates, biometric data, or another type of credential as part of an authentication process.

In block 409, the enterprise service 103 can receive a request to access to a protected resource 153. The enterprise service 103 can enable enterprise activities that include or involve accessing a protected resource 153 on demand or based at least in part on predetermined inputs from the client device 107. The enterprise service 103 identify the predetermined inputs as a request to access to the protected resource 153.

In block 412, the enterprise service 103 can transmit an authentication map 152 and a corresponding timestamp 136 to the client device 107. In some examples, no timestamp 136 is used. The enterprise service 103 can track which authentication maps 152 have been used. In some examples, the authentication service 103 can maintain a data structure that relates a client device identifier or a user identifier to the authentication map 152 once it has been transmitted. The user identifier can identify a user of the client device 107. The authentication map 152 and corresponding timestamp 136 can enable the client device 107 to obtain a token 138 that provides access to the protected resource 153.

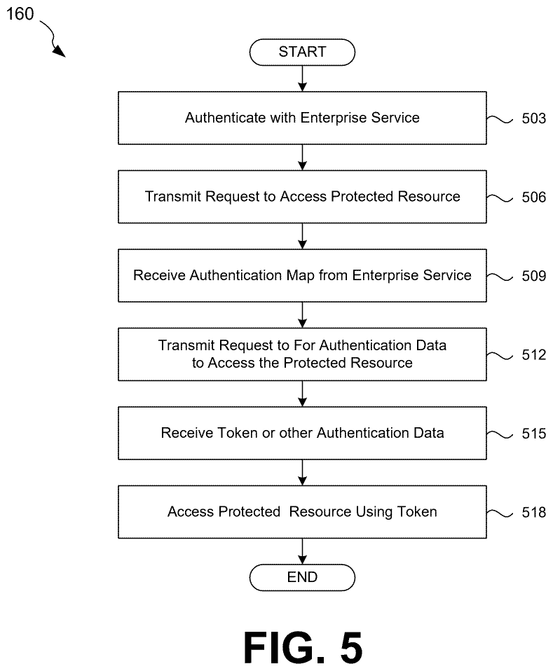

FIG. 5 shows a flowchart that provides an example of the operation of the client application 160 of the client device 107, for hybrid authentication using quantum key distribution. The flowchart of FIG. 5 provides merely an example of the many different types of functional arrangements that can be employed to implement the depicted interactions between the components of the networked environment 100. As an alternative, the flowchart of FIG. 5 can be viewed as depicting an example of elements of a method implemented within the networked environment 100.

In block 503, the client application 160 can authenticate with the enterprise service 103. The client application 160 can refer to a browser application, an enterprise-provided application, or other instructions executed using the client device 107. The client application 160 can authenticate with the enterprise service 103 by transmitting a username and password, digital certificates, biometric data, or another type of credential.

In block 506, the client application 160 can transmit a request to access to a protected resource 153. The enterprise service 103 can enable enterprise activities that include or involve accessing a protected resource 153 on demand or based at least in part on predetermined inputs from the client device 107. The client application 160 can transmit user interface navigation inputs and other types of data as a request to access to the protected resource 153.

In block 509, the client application 160 can receive an authentication map 152 and a corresponding timestamp 136. In some examples, no timestamp 136 is used. The client application 160 can receive the authentication map 152 and the corresponding timestamp 136 based at least in part on the request to access to the protected resource 153.

In block 512, the client application 160 can transmit the authentication map 152 and the timestamp 136 to the authentication service 120 for verification. In some examples, no timestamp 136 is used. The transmission of the authentication map 152 and the timestamp 136 can be referred to as a token request. The authentication service 120 can perform a verification of the authentication map 152.

In block 515, the client application 160 can receive a token 138 that enables access to the protected resource 153. The client application 160 can receive the token 138 based at least in part on the token request.

In block 518, the client application 160 can access the protected resource 153 using the token 138. The client device 107 can authenticate with the network service 105 using the token 138, thereby gaining access to the protected resource 153. The network service 105 can be a portion of the enterprise service 103 in some examples.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages could be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) can also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
at least one computing device comprising at least one processor and at least one memory; and
machine-readable instructions stored in the at least one memory that, when executed by the at least one processor, cause the at least one computing device to at least:
generate a batch of authentication keys comprising a plurality of authentication keys;
generate a key accumulator by inputting a respective authentication key of the plurality of authentication keys into an accumulator function;
generate, for the respective authentication key, a respective witness of a plurality of witnesses corresponding to the plurality of authentication keys, wherein the respective witness enables regeneration of the accumulator using the respective witness and the respective authentication key; and
transmit, using a quantum key distribution channel, a batch of authentication maps comprising a plurality of key-witness pairs comprising the respective witness and the respective authentication key.

2. The system of claim 1, wherein machine-readable instructions stored in the at least one memory that, when executed by the at least one processor, cause the at least one computing device to at least:
receive, from a client device, a particular authentication key and a particular witness; and
verify whether the particular authentication key is valid based at least in part on processing the particular authentication key and the particular witness to generate a value and comparing the value to the key accumulator.

3. The system of claim 2, wherein machine-readable instructions stored in the at least one memory that, when executed by the at least one processor, cause the at least one computing device to at least:
transmit, to the client device, a token that provides access to a protected resource stored by a network service.

4. The system of claim 1, wherein the batch of authentication keys is associated with a timestamp.

5. The system of claim 4, wherein the timestamp is used as a key to identify the key accumulator from a plurality of timestamped key accumulators.

6. The system of claim 1, wherein the quantum key distribution channel comprises an optical fiber.

7. The system of claim 1, wherein the accumulator function comprises a one-way cryptographic function that takes the batch of authentication keys as a set of inputs to generate the key accumulator as an output value.

8. A method, comprising:
receiving, by an authentication service, a particular authentication key and a particular witness;
verifying, by the authentication service, whether the particular authentication key is valid based at least in part on processing the particular authentication key and the particular witness to generate a value, and comparing the value to a key accumulator, wherein the key accumulator is cryptographically generated using a one-way cryptographic function; and
transmitting, by the authentication service, a token that provides access to a protected resource stored by a network service based at least in part on the value matching the key accumulator.

9. The method of claim 8, further comprising:
transmitting, by the authentication service, a batch of authentication maps using a quantum key distribution channel, wherein batch of authentication maps comprises a plurality of authentication keys used as inputs to the one-way cryptographic function to generate the key accumulator.

10. The method of claim 8, further comprising:
generating, by the authentication service, a key revocation accumulator that is generated using at least one revoked authentication key as at least one input to generate the key revocation accumulator as an output value.

11. The method of claim 10, wherein verifying whether the particular authentication key is valid based at least in further part on processing the particular authentication key to determine whether the particular authentication key is used to generate the key revocation accumulator.

12. The method of claim 8, wherein the particular authentication key and the particular witness are received in association with a batch identifier.

13. The method of claim 12, further comprising:
retrieving the key accumulator based at least in part on the batch identifier.

14. The method of claim 12, wherein the batch identifier comprises a timestamp.

15. A non-transitory computer readable medium comprising machine-readable instructions that, when executed by at least one processor, cause at least one computing device to at least:
generate a batch of authentication keys comprising a plurality of authentication keys;
generate a key accumulator by inputting a respective authentication key of the plurality of authentication keys into an accumulator function;
generate, for the respective authentication key, a respective witness of a plurality of witnesses corresponding to the plurality of authentication keys, wherein the respective witness enables regeneration of the accumulator using the respective witness and the respective authentication key; and
transmit, using a quantum key distribution channel, a batch of authentication maps comprising a plurality of key-witness pairs comprising the respective witness and the respective authentication key.

16. The non-transitory computer readable medium comprising of claim 15, wherein the instructions cause the at least one computing device to at least:
receive, from a client device, a particular authentication key and a particular witness; and
verify whether the particular authentication key is valid based at least in part on processing the particular authentication key and the particular witness to generate a value and comparing the value to the key accumulator.

17. The non-transitory computer readable medium comprising of claim 16, wherein the instructions cause the at least one computing device to at least:
transmit, to the client device, a token that provides access to a protected resource stored by a network service.

18. The non-transitory computer readable medium comprising of claim 15, wherein the batch of authentication keys is associated with a timestamp.

19. The non-transitory computer readable medium comprising of claim 18, wherein the timestamp is used as a key to identify the key accumulator from a plurality of timestamped key accumulators.

20. The non-transitory computer readable medium comprising of claim 15, wherein the quantum key distribution channel comprises an optical fiber.
